(19) United States
(12) Patent Application Publication
(10) Pub. No.: US 2025/0005338 A1
(43) Pub. Date: Jan. 2, 2025

(54) METHOD OF CUSTOMER SENTIMENT ANALYSIS USING LOGS AND FEEDBACK

(71) Applicant: Schlumberger Technology Corporation, Sugar Land, TX (US)

(72) Inventors: Omkar Anil Gune, Pune (IN); Purnaprajna Raghavendra Mangsuli, Pune (IN)

(21) Appl. No.: 18/760,432

(22) Filed: Jul. 1, 2024

(30) Foreign Application Priority Data
Jun. 30, 2023 (IN) 202311043960

(51) Int. Cl. G06N 3/0475; G06N 3/045; G06N 3/09

(52) U.S. Cl. CPC G06N 3/0475; G06N 3/045; G06N 3/09

(57) ABSTRACT

A method implements customer sentiment analysis using logs and feedback. Log data is received. The log data is processed with a text generation model to generate synthesized text. The synthesized text is processed with a sentiment prediction model to generate a sentiment prediction. The sentiment prediction model is trained with a training label received responsive to a similarity score of a training vector meeting a similarity threshold. The sentiment prediction is presented.

### CROSS-REFERENCE TO RELATED APPLICATIONS

This application claims priority to India patent application No. 202311043960, filed on Jun. 30, 2023, which is incorporated by reference.

### BACKGROUND

Machine learning methods using natural language processing (NLP) are effective in identifying end user sentiments from text data. However, such data may be limited or unavailable for certain end users of certain domains. For example, the feedback of end users of software systems may be limited to feedback surveys and tickets that may be unreliable. Surveys may have insufficient domain understanding and be neglected or biased, while tickets may provide insufficient text data for sentiment analysis. A challenge is for automated systems is to use natural language processing for sentiment analysis where text data may be lacking or otherwise unavailable.

### SUMMARY

In general, in one or more aspects, the disclosure relates to a method implementing customer sentiment analysis using logs and feedback. Log data is received. The log data is processed with a text generation model to generate synthesized text. The synthesized text is processed with a sentiment prediction model to generate a sentiment prediction. The sentiment prediction model is trained with a training label received responsive to a similarity score of a training vector meeting a similarity threshold. The sentiment prediction is presented.

Other aspects of the disclosure will be apparent from the following description and the appended claims.

### BRIEF DESCRIPTION OF DRAWINGS

FIG. 1 shows a diagram of a system in accordance with disclosed embodiments.

FIG. 2.1, FIG. 2.2, and FIG. 2.3 show flowcharts in accordance with disclosed embodiments.

FIG. 3, FIG. 4.1, and FIG. 4.2 show examples in accordance with disclosed embodiments.

FIG. 5.1 and FIG. 5.2 show computing systems in accordance with disclosed embodiments.

### DETAILED DESCRIPTION

Embodiments of the disclosure address the challenges of using natural language processing for sentiment analysis where text data may be lacking, insufficient, or otherwise unavailable. A machine learning model for sentiment analysis as opposed to using rule-based models because sentiment analysis can be effective using machine learning based natural language processing techniques whereas rule-based systems may not be scalable to address the diverse scenarios of user interactions with systems.

As an example, a user interacts with a software system that generates system logs in response to the user interaction. From the system logs, synthesized text is generated from which a sentiment analysis is performed to predict a sentiment of the user for using the system based on the system logs. If the system identifies that the circumstances for the user are different than what has previously been encountered by the system, the system may request additional feedback from the user to directly identify the sentiment of the user.

Embodiments of the disclosure address issues with data and labels. Data issues may be addressed with computing systems by generating large textual data from system interaction logs. Label issues may be addressed with computing systems by overcoming the challenges associated with feedback surveys by not prompting for feedback each time a service or software is used by a user and providing labels from customer ticket data.

Regarding data generation, systems generate textual descriptions using system logs. While using a particular software service/product, user interactions with the system are recorded in the form of system logs. For example, successful start of a software service/product, successful termination of software service, and intermediate operation logs may be recorded. Additionally, other statistics such as duration of product/service use, frequency of use, and geographical spread of usage of service can be obtained from the system logs. The system logs and statistics describe the user experience regarding the systems and services being used. The systems convert the statistics and interactions into a textual description about system interaction in a natural language that may be parsed using natural language processing analysis techniques.

Regarding label acquisition, issues arise with infrequent surveys and feedback. Additionally, frequent feedback forms and surveys may have issues of extreme responding and feedback forms may have issues with domain understanding. For robust performance of algorithmic techniques (including supervised artificial intelligence techniques), labels for the data may be used.

With sentiment analysis, the labels, i.e., the sentiment identifiers that identify the sentiments of the users may be obtained from feedback surveys. However, getting feedback from users may be counterproductive due to user bias or neglect from too many feedback requests or feedback requests that are out of context of the user experience. Embodiments of the disclosure may utilize infrequent and short feedback at the end of use of product/service, e.g., ratings for services being used. Prompting users each time at the end of usage may irritate the user, which may result in hyperbolic responses from users and incorrect labels for sentiments. Embodiments of the disclosure reduce the feedback sought from users. To reduce the number of feedback requests to users, the system may identify similar user experiences, based on system logs and statistics, and request feedback for user experiences that do not share similarity with user experiences for which sentiments have already been identified. Historic ticket data may be a source of labels.

To acquire labels (corresponding to sentiment identifiers) from users, system logs are converted into a feature vector (also referred to as a log vector or “vector”). The feature vector is compared with previously generated feature vectors for similarity. For the given vector, lower similarity with existing vectors corresponds to the scenario where the user interaction with system substantially differs from the user interactions observed so far from the system logs. In such case, a label is requested from the user and the system may be updated with vector and label pair. When the vector is similar to a previously generated vector, user feedback is not required, and the label identified based on similarity of the vector to a previously generated vector. The user provided feedback and label is used to train and improve the machine learning models of the system.

During training of natural language processing-based sentiment analyzer, user interactions with the system are logged and various statistics are obtained. A textual description generator converts this statistics and logs into natural language text. At start, sentiment labels for the generated text are obtained from the user in the form of short feedback such as rating or using existing ticket data. The sentiment analyzer is trained on synthetically generated textual descriptions from system logs and labels provided by the user or from ticket data. As the system iterates and updates, labels are requested from user when a user interaction experience with system (qualified by the system logs and statistics) are new and have not been previously observed. Requesting labels for interactions that have not been previously observed overcomes the issues of extreme biases in user feedback due to repetitive prompting for feedback. Thus, user may be prompted for feedback occasionally instead of repetitively. For user interaction experiences that are similar to previously observed interactions, labels for the previous interactions are retrieved and used to avoid requesting additional feedback. The synthesized text and improved labels (sentiments from feedback) are used in training and fine tuning of the existing natural language processing-based sentiment analyzer.

During testing (in the absence of customer feedback), the system interaction logs and statistics are first converted into text. The synthesized text is given as an input to the natural language processing-based sentiment analyzer to predict customer sentiment.

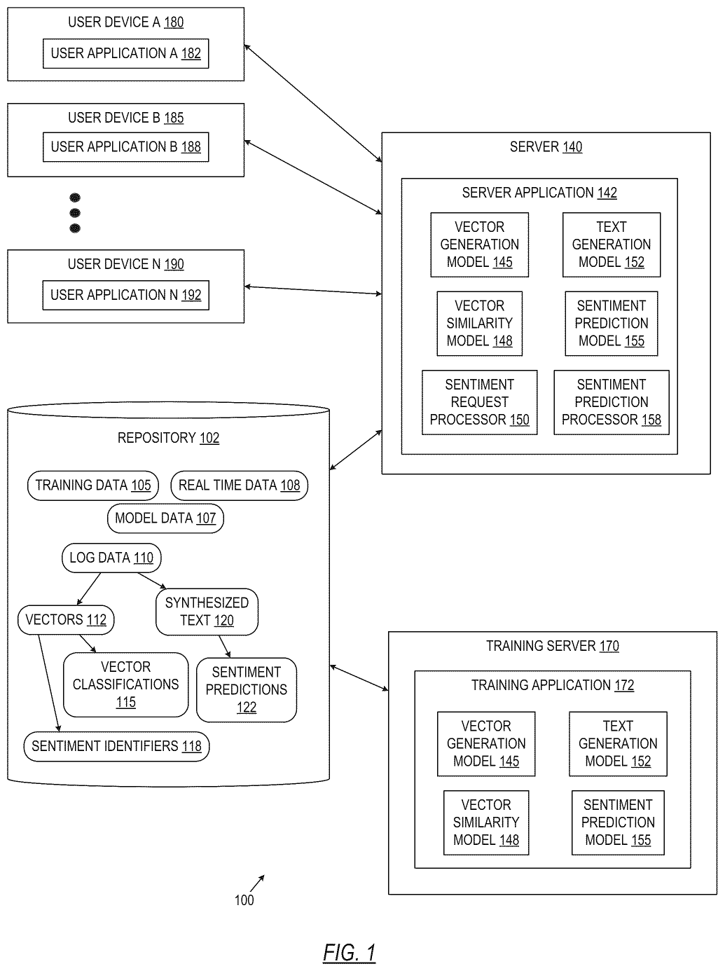

Turning to FIG. 1, the system (100) uses natural language processing for sentiment analysis where text data may be lacking, insufficient, or otherwise unavailable. Users operate the user devices A (180) and B (185) through N (190) to interact with software provided by the server (140). The interaction of the user devices A (180) and B (185) through N (190) with the server (140) generates the log data (110) stored in the repository (102). The log data (110) is processed by the server (140) with the server application (142) to generate the vectors (112), the vector classifications (115), the sentiment identifiers (118), the synthesized text (120), and the sentiment predictions (122). Responsive to the vector classifications (115), the system (100) may send feedback requests to the user devices A (180) and B (185) through N (190) to ask users for their sentiments regarding use of the system (100), in which the user responses may be processed to generate the sentiment identifiers (118). Responsive to the sentiment predictions (122), the system (100) may drive additional interaction with the users of the user devices A (180) and B (185) through N (190).

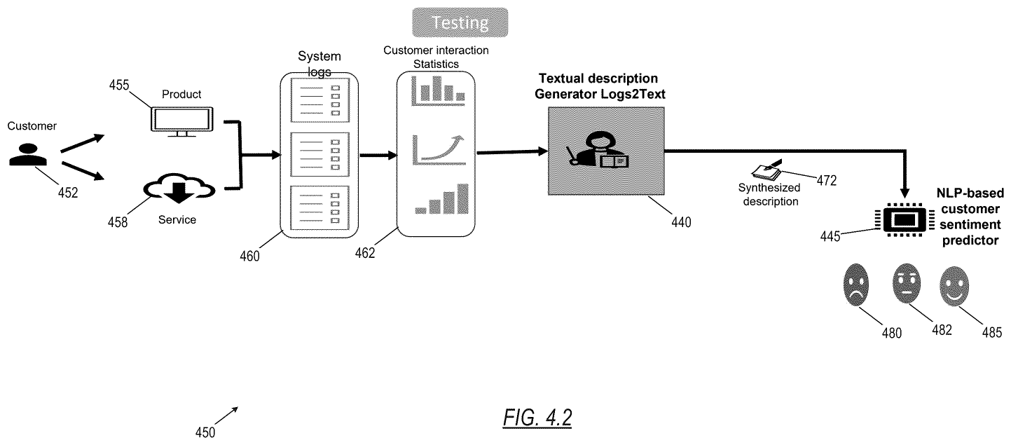

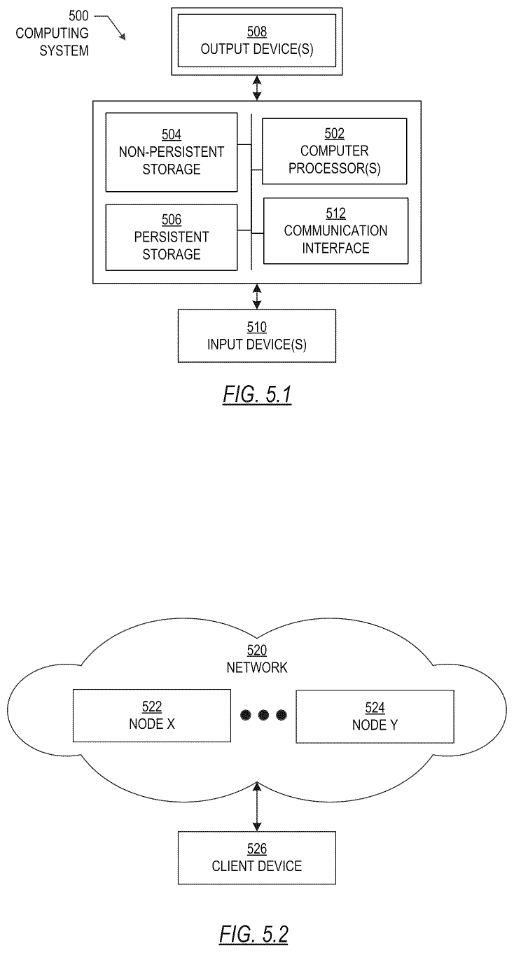

The repository (102) is a computing system that may include multiple computing devices in accordance with the computing system (500) and the nodes (522) and (524) described below in FIGS. 5.1 and 5.2. The repository (102) may be a database hosted by a cloud service provider. The cloud service provider may provide hosting, virtualization, and data storage services as well as other cloud services and may operate and control the data, programs, and applications of the system (100). The data in the repository (102) may include the training data (105), the real time data (108), the log data (110), the vectors (112), the vector classifications (115), the sentiment identifiers (118), the synthesized text (120), and the sentiment predictions (122). The data in the repository (102) may be processed by programs executing on the system (100) as described below. The data of the repository (102) may be stored in multiple computer data files.

The training data (105) is data used to train the machine learning models of the system (100). The machine learning models are stored in the model data (107) and may include the vector generation model (145), the vector similarity model (148), the text generation model (152), and the sentiment prediction model (155). The training data (105) include historical system logs generated in response to users interacting with the system (100).

The model data (107) stores at the data of the machine learning models used by the system (100). The model data (107) includes the weights, parameters, metadata, etc., used to operate and train the machine learning models. The model data (107) may be iteratively updated by training the machine learning models with the training data (105).

The real time data (108) is data that is received or generated in real time by the system (100). The real time data (108) includes the system logs generated responsive to user interactions with the system (100) and stored as the log data (110).

The log data (110) are the system logs generated responsive to user interactions with the system (100). The log data (110) may be processed on a per user basis periodically. For example, the log data (110) for a user may be processed hourly, daily, weekly, monthly, etc. In one embodiment, the log data (110) is processed on demand. For example, the log data (110) for a user may be processed responsive to the generation of a system log. In one embodiment, the log data (110) includes system logs with log events for successful start of a software service and successful termination of software service as well as intermediate operation logs, etc.

In one embodiment, the system (100) provides target services that provide functionality to the user. The target services include the software and hardware that provide the functionality for the user to achieve the objective. In addition to the target services, the system may provide technical support in the form of help files, real or virtual customer service agents, and other such support. Events and corresponding logs for accessing technical support may be different than the events and logs for accessing the target services. When using the system, the user interacts with the target service (e.g., sending and receiving requests and responses), which are stored in the system logs used to determine user sentiment. In one embodiment, the system logs may also include events of user interaction with technical support to determine user sentiment. In one embodiment, an event is an entry in a log that describes the type of event, the time of the event, etc.

In one embodiment, the log data (110) may also include log statistics that are statistics generated from the log data. For example, the log statistics may include duration of service use, frequency of use, geographical spread of usage of a service, etc. Additional events and statistics may be used to form the log data (110) from system logs captured by the system (100).

The vectors (112) are sets of data generated from the log data (110). In one embodiment, a vector, which may also be referred to as a log vector, includes a number of numerical values generated from the log data (110). The numerical values may be discrete or continuous values generated from categorical, string, and numerical data from the log data (110).

The vector classifications (115) are classifications for the vectors (112). In one embodiment, the vector classifications (115) are mappings of the vectors (112) to the sentiment identifiers (118). In one embodiment, one vector classification (of the vector classifications (115)) maps one sentiment identifier (of the sentiment identifiers (118)) for one vector (of the vectors (112)) to one set of log data (from the log data (110)) for one user.

The sentiment identifiers (118) are identifiers of a sentiment for a set of log data from the log data (110). The sentiment identifiers (118) may be provided by the users of the system (100) in response to feedback requests from the system (100). The sentiment identifiers (118) may also be generated (e.g., predicted) automatically by the system in response to the log data (110). In one embodiment, a sentiment identifier (of the sentiment identifiers (118)) identifies between the sentiment values of “negative”, “neutral”, and “positive”. A “negative” sentiment value, when provided identified by a user, indicates that the user is not satisfied with the interactions with the system (100) and may reduce system interactions from current levels. A “neutral” sentiment value, when provided identified by a user, indicates that the user may be satisfied with the usage of the system and may maintain system interactions at current levels. A “positive” sentiment value, when provided identified by a user, indicates that the user may be satisfied with the usage of the system and may increase system interactions from current levels.

Different types of sentiments with different levels of granularity may be used. For example, the sentiments may use a scale of 0-10 with “0” being “very unhappy” and “10” being “very happy”. Additionally, the five sentiments of “very happy”, “happy”, “neutral”, “unhappy”, and “very unhappy” may be used.

The synthesized text (120) is text generated from the system logs of the log data (110). The synthesized text (120) may be stored as text data or as vector data for use in the machine learning models of the system (100). In one embodiment, one set of synthesized text (of the synthesized text (120)) is generated for one set of log data (from the log data (110)) for one user. The synthesized text (120) describes the interactions of the user with the system (100) as captured by the system logs of the log data (110). In one embodiment, the synthesized text (120) is text that is a narrative that summarizes and describes the interactions with the system by a user in a natural language.

The sentiment predictions (122) are predictions of sentiments of users that are generated from the system logs of the log data (110). In one embodiment, one sentiment prediction (of the sentiment predictions (122)) predicts the sentiment for one set of synthesized text (of the synthesized text (120)) for one set of log data (from the log data (110)) for one user. In one embodiment, a sentiment prediction (of the sentiment predictions (122)) may be a vector with three continuous values between 0 and 1 that identify the likelihood of one of the sentiment values of “negative”, “neutral”, and “positive”. As noted above, more than three sentiments may be used.

The server (140) is a computing system (further described in FIG. 5.1). The server (140) may include multiple physical and virtual computing systems that form part of a cloud computing environment. In one embodiment, execution of the instructions, programs, and applications of the server (140) is distributed to multiple physical and virtual computing systems in the cloud computing environment. The server (140) may include the server application (142).

The server application (142) is a collection of programs with instructions that may execute on multiple servers of a cloud environment, including the server (140). The server application (142) is configured to process the log data (110). The server application (142) utilizes a collection of hardware and/or software components with programs and instructions that may operate on the server (140), which may include the vector generation model (145), the vector similarity model (148), the sentiment request processor (150), the text generation model (152), the sentiment prediction model (155), and the sentiment prediction processor (158).

The vector generation model (145) may include hardware and software components to generate the vectors (112) from the log data (110). The vector generation model (145) may perform transformations on the log data (110) and use machine learning models to generate the vectors (112). For example, the vector generation model (145) transforms categorical values from the log data (110) to discrete values for the vectors (112) and may input the discrete values to an embedding model (also referred to as an encoding model) to generate the vectors (112) as embedding vectors.

The vector similarity model (148) may include hardware and software components to identify the similarity between the vectors (112). The similarity between two vectors may be quantified as a similarity score calculated using functions, machine learning models, etc. For example, a similarity score may be calculated as the cosine similarity between two vectors. As another example, a machine learning similarity model may take two vectors as input and output a similarity score.

The sentiment request processor (150) may include hardware and software components to collect the sentiment identifiers (118). In one embodiment, the sentiment request processor (150) sends feedback requests to users in response to identifying instead of log data (from the log data (110)) that is different from previous sets of log data. In one embodiment, the feedback requests generated by the sentiment request processor (150) may be in the form of emails sent to user of the system. Different types of messaging and contact may be used.

The text generation model (152) may include hardware and software components to generate the synthesized text (120) from the log data (110). The text generation model (152) may use one or more transformations and machine learning models to generate the synthesized text (120) from the log data (110). In one embodiment, the text generation model (152) may use machine learning models that include generative diffusion models, generative adversarial models, etc.

The sentiment prediction model (155) may include hardware and software components to generate the sentiment predictions (122) from the synthesized text (120). The sentiment prediction model (155) may use one or more transformations and machine learning models to generate the sentiment predictions (122) from the synthesized text (120). In one embodiment, the sentiment prediction model (155) may use machine learning models that include neural network models.

The sentiment prediction processor (158) may include hardware and software components to process the sentiment predictions (122). In one embodiment, the sentiment prediction processor (158) may generate and send messages to the user devices A (180) and B (185) through N (190) based on the sentiment predictions (122). For example, a message responsive to a negative sentiment prediction may ask for suggestions to improve the system (100) and a message responsive to a positive sentiment prediction may thank the user for continued use of the system (100).

The training server (170) is a computing system (further described in FIG. 5.1). The training server (170) may include multiple physical and virtual computing systems that form part of a cloud computing environment. In one embodiment, execution of the instructions, programs, and applications of the training server (170) is distributed to multiple physical and virtual computing systems in the cloud computing environment. The training server (170) may include the training application (172). In one embodiment, the training server (170) and the server (140) may be embodied as a single computing system that operates both the server application (142) and the training application (172).

The training application (172) is a collection of programs with instructions that may execute on multiple servers of a cloud environment, including the training server (170). The training application (172) uses the training data (105) to train the machine learning models utilized by the system (100), which may include the vector generation model (145), the vector similarity model (148), the text generation model (152), and the sentiment prediction model (155). For each model, the model may be trained for a group of users or for a single user. The training application (172) uses machine learning algorithms to train and update the machine learning models of the system (100). The machine learning algorithms may include algorithms that perform reinforcement learning, deep learning, etc. For example, reinforcement learning may include comparing the output of a model to a label to identify an error between the output and the label and then use backpropagation to update the model with adjusted weights and parameters of the model to reduce the error of the model.

The user devices A (180) and B (185) through N (190) are computing systems (further described in FIG. 5.1). For example, the user devices A (180) and B (185) through N (190) may be desktop computers, mobile devices, laptop computers, tablet computers, server computers, etc. The user devices A (180) and B (185) through N (190) include hardware components and software components that operate as part of the system (100). The user devices A (180) and B (185) through N (190) communicate with the server (140) to access, manipulate, and view services and information hosted by the system (100). The user devices A (180) and B (185) through N (190) may communicate with the server (140) using standard protocols and file types, which may include hypertext transfer protocol (HTTP), HTTP secure (HTTPS), transmission control protocol (TCP), internet protocol (IP), hypertext markup language (HTML), extensible markup language (XML), etc. The user devices A (180) and B (185) through N (190) respectively include the user applications A (182) and B (188) through N (192).

The user applications A (182) and B (188) through N (192) may each include multiple programs respectively executing on the user devices A (180) and B (185) through N (190). The user applications A (182) and B (188) through N (192) may be native applications, web applications, embedded applications, etc. In one embodiment, the user applications A (182) and B (188) through N (192) include web browser programs that display web pages from the server (140).

Although shown using distributed computing architectures and systems, other architectures and systems may be used. In one embodiment, the server application (142) may be part of a monolithic application that performs image background removal. In one embodiment, the user applications A (182) and B (188) through N (192) may be part of monolithic applications that perform image background removal without the server application (142).

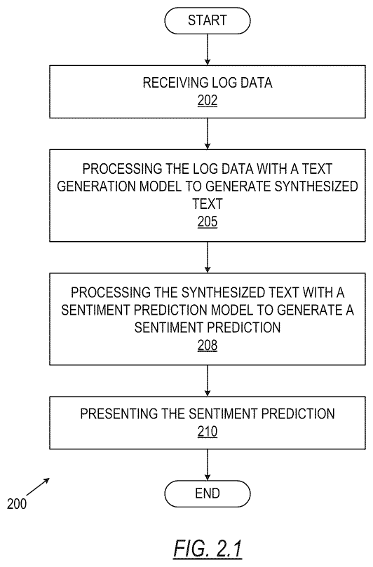

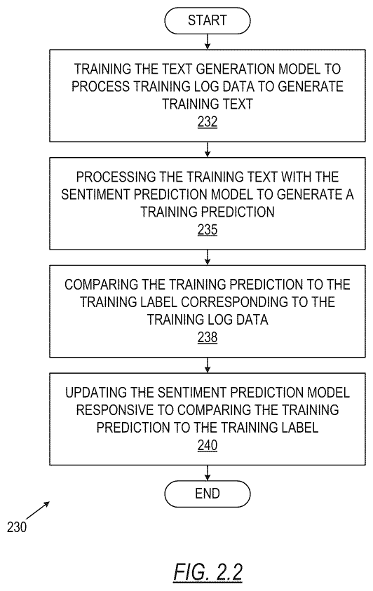

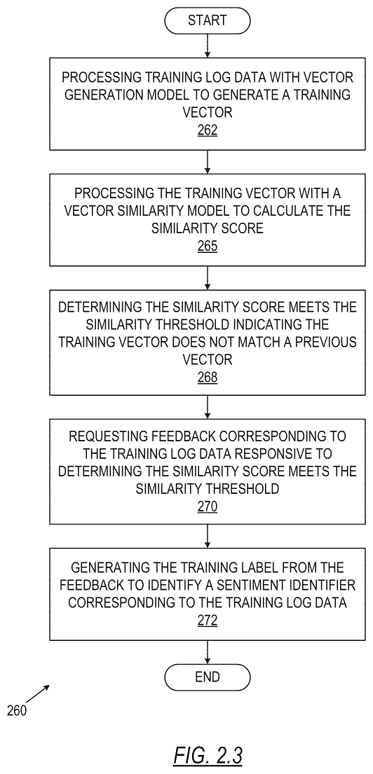

Turning to FIG. 2.1, the process (200) uses natural language processing for sentiment analysis. The process (200) may be performed by a computing device interacting with one or more additional computing devices. For example, the process (200) may execute on a server response to one or more user devices.

At Block 202, log data is received. The log data may include system logs and log statistics for a user of the system. In one embodiment, the log data is received responsive to accessing a repository for the log data. The system may operate periodically or on demand to process log data. In one embodiment, the log data is a set of system logs and log statistics for a user of the system over a defined period of time. In one embodiment, the log data includes system logs with log events identifying successful start of a software service and successful termination of software service as well as intermediate operation logs.

In one embodiment, log statistics are obtained from system logs to form the log data. The log statistics may be generated on a periodic basis. In one embodiment, the log statistics include statistics identifying duration of service use, frequency of use, and geographical spread of usage of a service. The service being accessed may be a software product or service.

As an example, user may access a service (e.g., by logging into a website or opening a desktop or mobile application), and then proceed to interact with the service. Each of the interactions, including the login, may be stored as an event in a system log. The system may periodically (daily, weekly, monthly, etc.) analyze the events to generate log statistics that are combined with the system logs to form the log data.

At Block 205, the log data is processed with a text generation model to generate synthesized text. In one embodiment, the text generation model uses one or more of an image to text model, a transformer model, a generative adversarial model, and a generative diffusion model to generate the synthesized text. The system logs and statistics of the log data are converted to vectors (which may be referred to as log vectors) of numerical data that are input to other transforms and models to generate the synthesized text.

In one embodiment, the statistics are processed to generate a graph showing periodic (e.g., daily) statistics of events triggered by interactions of a user with the system. The image (or the underlying statistics) may then be input to a machine learning model that generates text from the image. For example, the events and statistics extracted and calculated from system logs may be plotted onto a graph to form an image that is input to a machine learning model. The machine learning model uses an image to text model to generate text from the image generated from the system logs.

In one embodiment, a log vector may be input to a transformer model that translates from the log vector to word embedding vectors. For example, data from the events and statistics extracted and calculated from system logs may be concatenated to form the log vector, which is input to the machine learning model. The machine learning model uses a transformer model to convert the log vector input to word vectors and corresponding text for the system logs.

In one embodiment, a generative adversarial network is used in which a generative network generates word embedding vectors from the input (e.g., the log vectors), and in which the generative network is trained with an adversarial network to generate appropriate or embedding vectors for the input. For example, the generative model may include a transformer model that generates text from a vector generated from the system logs and statistics. Supervised training may be used to compare outputs of the generative model to text that was previously paired with the vectors input to the generative model. The output of the generative model, e.g., word vectors for synthesized text, is input to an adversarial model that outputs a prediction of whether the input to the adversarial model matches with text paired with the vector input.

In one embodiment, a generative diffusion model is used that starts with random noise and reduces the noise to a set of word embedding vectors that represent the original log data. For example, the random noise may be formed as a vector with the same number of dimensions as the sequence of word embedding vectors that are output from the diffusion model. The diffusion model processes the input to reduce the noise in the input and generate the output. During training, the output is compared with sequences of word embedding vectors that have been stored by the system.

At Block 208, the synthesized text is processed with a sentiment prediction model to generate a sentiment prediction. In one embodiment, the sentiment prediction model converts the synthesized text to word embedding vectors that are input to a neural network model that outputs the sentiment prediction. In one embodiment, the sentiment prediction output from the central prediction model is a vector in which the values within the vector identify the likelihoods of different sentiments for the synthesized text. For example, a sentiment prediction vector of [0.1, 0.2, 0.7] may identify a 10 percent chance of negative sentiment, a 20 percent chance of neutral sentiment, and a 70 percent chance of positive sentiment. A sentiment prediction vector may be mapped to a single categorical value (e.g., “negative”, “neutral”, “positive”, or other sentiments, which may have different granularities). In one embodiment, reinforcement learning is used to train the sentiment prediction model.

In one embodiment, the sentiment prediction model is trained with a training label received responsive to a similarity score of a training vector meeting a similarity threshold. The similarity threshold identifies a level of similarity between two sets of log data (represented by two log vectors) to identify whether a first set of log data represents a different circumstance than a second set of log data. For example, set of log data may indicate that the user has successful login to the system daily over the last 20 days, which may be identified as similar to another set of log data that indicates that a different user has successfully logged into the system over 19 of the last 20 days. However, a third set of log data indicating that the user has not successfully logged in to the system for the last 30 days may be identified as a different circumstance than the first two sets of log data.

In one embodiment, a similarity threshold is a scalar value between 0 and 1 with lower values indicating lower similarity and higher values indicating higher similarity. Continuing the previous example, the first and second sets of log data may have a similarity of 0.95, where is the first and third sets of log data have a similarity of 0. When the similarity score does not meet the similarity threshold, the system may send a message to the user with a feedback request for the user to identify a sentiment for using the system.

In one embodiment, the sentiment prediction model comprises one or more of a natural language processing (NLP) model and a transformer model. The transformer model may form part of a natural language processing model. The transformer model may take as input word embedding vectors generated for the synthesized text and output a set of vectors that are input to a linear model (also referred to as a fully connected neural network) that outputs the sentiment prediction.

In one embodiment, the sentiment prediction comprises a sentiment classification of one of positive, neutral, and negative. Different classifications may be used with different resolutions and different sentiment identifiers. For example, the sentiments may use a scale of 0-10 with “0” being “very unhappy” and “10” being “very happy” for classificaiton. Additionally, the five sentiment identifiers of “very happy”, “happy”, “neutral”, “unhappy”, and “very unhappy” may be used for classification. The output of the sentiment prediction model may be a vector with values for each of the possible classifications and the classification with the highest value in a vector may be identified as the sentiment prediction.

At Block 210, the sentiment prediction is presented. In one embodiment, presenting the sentiment prediction may include sending an email to an end user. For example, when sentiment prediction is “negative” the email may request suggestions for improving the user experience with the system. When the sentiment prediction is “neutral” the email may encourage additional use of the system by the user. When the sentiment prediction is “positive” the email may thank the user.

Turning to FIG. 2.2, the process (230) trains a sentiment prediction model. The process (230) may be performed by a computing device interacting with one or more additional computing devices. For example, the process (230) may execute on a server response to one or more user devices.

At Block 232, a text generation model is trained to process training log data to generate training text. The training log data is the system logs and statistics for historical usage of the system by the users of the system. The text generation model is updated using the training text. In one embodiment, the training text output by the text generation model may be compared to sample text corresponding to the training log data. Errors between the sample text and the training text may be backpropagated as updates through the text generation model to improve the accuracy of the text generation model.

At Block 235, the training text is processed with the sentiment prediction model to generate a training prediction. Training text that is output from the text generation model is input to the sentiment prediction model.

At Block 238, the training prediction is compared to a training label corresponding to the training log data. The training label is a sentiment identifier for the training log data that identifies the sentiment of the user for the training log data.

At Block 240, the sentiment prediction model is updated responsive to comparing the training prediction to the training label. The comparison may identify an error between the training prediction and the training label, and the error may be backpropagated as updates through the sentiment prediction model and improve the accuracy of the sentiment prediction model.

Turning to FIG. 2.3, the process (260) generates feedback requests responsive to the similarity scores between vectors for log data. The process (260) may be performed by a computing device interacting with one or more additional computing devices. For example, the process (260) may execute on a server response to one or more user devices.

At Block 262, training log data is processed with a vector generation model to generate a training vector. In one embodiment, the vector generation model may transform the categorical, string, and numerical data from the log data to numerical values that are discrete or continuous values. The vector is a feature vector (which may also be referred to as a log vector) that includes values for the features of the log data. A feature is a value of the feature vector that corresponds to an aspect of the log data. For example, one feature may identify the average number of login requests over the last 30 days for a user. Additional features may be used.

At Block 265, the training vector is processed with a vector similarity model to calculate a similarity score. The vector similarity model uses one or more functions and algorithms to identify the similarity between vectors. The functions and algorithms may include cosine similarity algorithms, neural network algorithms, etc. In one embodiment, the similarity score is a scalar value between 0 and 1 with lower values towards 0 indicating that the input vectors are not similar and higher values towards one indicating that the vectors are similar.

At Block 268, it is determined if the similarity score meets a similarity threshold to indicate the training vector does not match a previous vector in a database. For example, when the similarity threshold is 0.5 and the cosine similarity between two vectors meets the similarity threshold by being less than the similarity threshold, then the system identifies that the vectors do not match. Vectors that do not match with the vectors previously generated for previous log data may then be further processed. Vectors that do match with previous vectors for previous log data may be mapped to the sentiment identifiers that are mapped to the previous vectors.

At Block 270, feedback is requested that corresponds to the training log data in response to determining the similarity score meets the similarity threshold. The training log data for which feedback is requested corresponds to the vector that does not match to the previous vectors. In one embodiment, the feedback may be requested by sending a message to the user requesting the user to identify a sentiment (e.g., “satisfied”, “neutral”, “dissatisfied”) for use of the system. The messaged may be an email, text message, notification, etc.

At Block 272, a training label is generated from the feedback to identify a sentiment identifier corresponding to the training log data. In one embodiment, the sentiment from the feedback is a categorical value (e.g., “satisfied”, “neutral”, “dissatisfied”) that is mapped to a categorical value for a sentiment identifier (e.g., “positive”, “neutral”, and “negative”) of the system.

In one embodiment, the feedback, from which the training label is generated, includes a rating. The rating may be from a user, which may be from two sources direct feedback or historic customer ticket data. Direct feedback may be gathered when the feature vector for log data is not similar to a preexisting feature vector for historical log data. Historic customer ticket data may be used when a feature vector is similar to a preexisting feature vector. Direct feedback may include a customer rating like “2/5 stars”. The customer ticket data may be from a help desk system and include a textual description of a problem or issue the user is having with the system. After resolution of the issue, the user may provide a rating, which may be converted to a sentiment identifier by mapping the value of the rating to the values for the sentiment identifiers of the system.

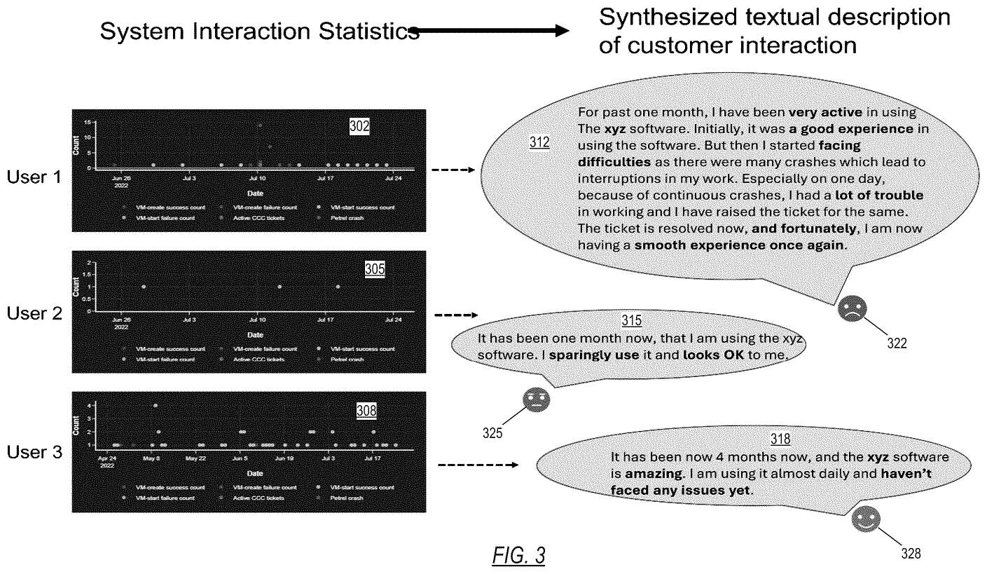

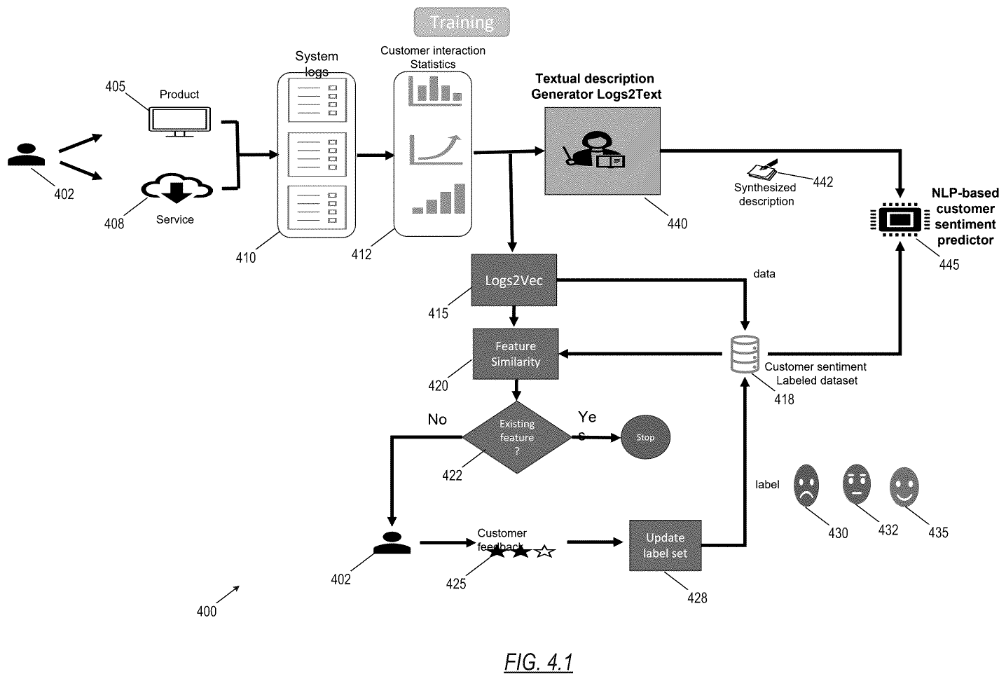

FIG. 3, FIG. 4.1, and FIG. 4.2 show examples of systems and methods performing customer sentiment analysis using logs and feedback. FIG. 3 illustrates sample data that may be used and generated by embodiments of the disclosure. FIG. 4.1 and FIG. 4.2 show systems and processes that train and use machine learning models to gather sentiment data for system logs and analyze system logs to generate sentiment predictions.

Turning to FIG. 3, the graphs (302), (305), and (308) illustrate system interaction statistics that are log data generated from system logs and statistics. The graphs (302), (305), and (308) (or the underlying data) are input to text generation models to generate the synthesized text (312), (315), and (318). The synthesized text (312), (315), and (318) are input to sentiment prediction models to generate the sentiment predictions (322), (325), (328).

Turning to FIG. 4.1, the system (400) stores labels of sentiments identified by users. The user (402) interacts with the system (400) through the software product (405) or the service (408). Interaction by the user (402) with the system (400) generates the system logs (410) from which the statistics (412) are generated. At Block 415, the system logs (410) and the statistics (412) are processed to generate vectors (also referred to as feature vectors or log vectors), which are stored in the repository (420). At Block 420, the similarity between a vector and the vectors previously generated by the system (also referred to as existing vectors or features) is compared. At Block 422, a determination of whether the vector is similar to one of the previously generated vectors. If the vector is similar to a previously generated vector, then the process stops without sending a feedback request to the user (402). If the vector is not similar to a previously generated vector, then a feedback request is sent to the user (402), which responds with the feedback (425).

At Block 428, a label set is updated to include a pairing of a label from the feedback (425) and the vector generated for the system logs (410) and the statistics (412). The label includes one of the sentiment identifiers (430), (432), and (435). The sentiment identifier (430) identifies a sentiment value of “negative”. The sentiment identifier (432) identifies a sentiment value of “neutral”. The sentiment identifier (435) identifies a sentiment value of “positive”. The pairing is stored to the repository (418).

After storing multiple labels, the system (400) trains the machine learning models used by the system. In one embodiment, after the system logs (410) and the statistics (412) are received and stored, the text generation model (440) (also referred to as a textual description generator) processes the system logs (410) and the statistics (412) to generate the synthesized text (442) (also referred to as synthesized description). The synthesized text (442) is input to the sentiment prediction model (445) (also referred to as a natural language processing-based sentiment predictor). The output of the sentiment prediction model (445) is compared to a label from the repository (418). The label from the repository (418) may be derived from the feedback (425) or may be preexisting in the repository (418) due to the feature vector similarity with existing feature vectors. Errors between the output of the sentiment prediction model (445) and the label is that propagated as updates to one or more of the sentiment prediction model (445) and the text generation model (440).

Turning to FIG. 4.2, the system (450) uses the models trained from the system (400) (of FIG. 4.1) to identify sentiments during live use. The user (452) logs in and interacts with the system (450) through the software product (455) or the service (458) to generate the system logs (460) and the statistics (462). After the system logs (460) and the statistics (462) are received and stored, the text generation model (440) (also referred to as a textual description generator) processes the system logs (460) and the statistics (462) to generate the synthesized text (472) (also referred to as synthesized description). The synthesized text (472) is input to the sentiment prediction model (445), which outputs one of the sentiment identifiers (480), (482), and (485). The system (450) may follow up with the user (452) by sending a message based on the output of the sentiment prediction model (445). The message may be delivered as a closing message when the user logs off from the system (450) or may be delivered as a welcome message the next time the user logs on to the system (450). For the sentiment identifier (480) (“negative”), the message may request suggestions from the user to improve the user experience. For the sentiment identifier (482) (“neutral”), the message may describe additional functionality available to the user (452) from the system (450). For the sentiment identifier (485) (“positive”), the message may thank the user for continued use of the system.

Embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure. For example, as shown in FIG. 5.1, the computing system (500) may include one or more computer processors (502), non-persistent storage (504), persistent storage (506), a communication interface (512) (e.g., Bluetooth interface, infrared interface, network interface, optical interface, etc.), and numerous other elements and functionalities that implement the features and elements of the disclosure. The computer processor(s) (502) may be an integrated circuit for processing instructions. The computer processor(s) may be one or more cores or micro-cores of a processor. The computer processor(s) (502) includes one or more processors. The one or more processors may include a central processing unit (CPU), a graphics processing unit (GPU), a tensor processing units (TPU), combinations thereof, etc.

The input devices (510) may include a touchscreen, keyboard, mouse, microphone, touchpad, electronic pen, or any other type of input device. The input devices (510) may receive inputs from a user that are responsive to data and messages presented by the output devices (508). The inputs may include text input, audio input, video input, etc., which may be processed and transmitted by the computing system (500) in accordance with the disclosure. The communication interface (512) may include an integrated circuit for connecting the computing system (500) to a network (not shown) (e.g., a local area network (LAN), a wide area network (WAN) such as the Internet, mobile network, or any other type of network) and/or to another device, such as another computing device.

Further, the output devices (508) may include a display device, a speaker, a printer, external storage, or any other output device. One or more of the output devices may be the same or different from the input device(s). The input and output device(s) may be locally or remotely connected to the computer processor(s) (502). Many different types of computing systems exist, and the aforementioned input and output device(s) may take other forms. The output devices (508) may display data and messages that are transmitted and received by the computing system (500). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments, which may include transmitting, receiving, presenting, and displaying data and messages described in the other figures of the disclosure.

The computing system (500) in FIG. 5.1 may be connected to or be a part of a network. For example, as shown in FIG. 5.2, the network (520) may include multiple nodes (e.g., node X (522), node Y (524)). Each node may correspond to a computing system, such as the computing system shown in FIG. 5.1, or a group of nodes combined may correspond to the computing system shown in FIG. 5.1. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (500) may be located at a remote location and connected to the other elements over a network.

The nodes (e.g., node X (522), node Y (524)) in the network (520) may be configured to provide services for a client device (526), including receiving requests and transmitting responses to the client device (526). For example, the nodes may be part of a cloud computing system. The client device (526) may be a computing system, such as the computing system shown in FIG. 5.1. Further, the client device (526) may include and/or perform all or a portion of one or more embodiments.

The computing system of FIG. 5.1 may include functionality to present raw and/or processed data, such as results of comparisons and other processing. For example, presenting data may be accomplished through various presenting methods. Specifically, data may be presented by being displayed in a user interface, transmitted to a different computing system, and stored. The user interface may include a GUI that displays information on a display device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be temporary, permanent, or semi-permanent communication channel between two entities.

The various descriptions of the figures may be combined and may include or be included within the features described in the other figures of the application. The various elements, systems, components, and steps shown in the figures may be omitted, repeated, combined, and/or altered as shown from the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, unless expressly stated otherwise, or is an “inclusive or” and, as such includes “and.” Further, items joined by an or may include any combination of the items with any number of each item unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A method comprising:
receiving log data;
processing the log data with a text generation model to generate synthesized text;
processing the synthesized text with a sentiment prediction model to generate a sentiment prediction, wherein the sentiment prediction model is trained with a training label received responsive to a similarity score of a training vector meeting a similarity threshold; and
presenting the sentiment prediction.

2. The method of claim 1, wherein training the sentiment prediction model comprises:
training the text generation model to process training log data to generate training text, wherein the text generation model is updated using the training text;
processing the training text with the sentiment prediction model to generate a training prediction;
comparing the training prediction to the training label corresponding to the training log data; and
updating the sentiment prediction model responsive to comparing the training prediction to the training label.

3. The method of claim 1, wherein receiving the training label includes requesting feedback by:
processing training log data with vector generation model to generate a training vector;
processing the training vector with a vector similarity model to calculate the similarity score;
determining the similarity score meets the similarity threshold indicating the training vector does not match a previous vector in a database;
requesting feedback corresponding to the training log data responsive to determining the similarity score meets the similarity threshold; and
generating the training label from the feedback to identify a sentiment identifier corresponding to the training log data.

4. The method of claim 1, wherein feedback, from which the training label is generated, comprises a rating.

5. The method of claim 1, wherein in the sentiment prediction model comprises one or more of a natural language processing (NLP) model and a transformer model.

6. The method of claim 1, wherein the sentiment prediction comprises a sentiment classification.

7. The method of claim 1, wherein the text generation model comprises one or more of an image to text model, a transformer model, a generative adversarial model, and a generative diffusion model.

8. The method of claim 1, for the comprising:
obtaining log statistics from system logs to form the log data.

9. The method of claim 1, wherein the log data comprises system logs with log events comprising successful start of a software service, successful termination of software service, and intermediate operation logs.

10. The method of claim 1, wherein the log data further comprises log statistics comprising duration of service use, frequency of use, and geographical spread of usage of a service.

11. A system comprising:
at least one processor;
an application executing on at least one processor to:
receive log data;
process the log data with a text generation model to generate synthesized text;
process the synthesized text with a sentiment prediction model to generate a sentiment prediction, wherein the sentiment prediction model is trained with a training label received responsive to a similarity score of a training vector meeting a similarity threshold; and
present the sentiment prediction.

12. The system of claim 11, wherein training the sentiment prediction model comprises:
training the text generation model to process training log data to generate training text, wherein the text generation model is updated using the training text;
processing the training text with the sentiment prediction model to generate a training prediction;
comparing the training prediction to the training label corresponding to the training log data; and
updating the sentiment prediction model responsive to comparing the training prediction to the training label.

13. The system of claim 11, wherein receiving the training label includes requesting feedback by:
processing training log data with vector generation model to generate a training vector;
processing the training vector with a vector similarity model to calculate the similarity score;
determining the similarity score meets the similarity threshold indicating the training vector does not match a previous vector in a database;
requesting feedback corresponding to the training log data responsive to determining the similarity score meets the similarity threshold; and
generating the training label from the feedback to identify a sentiment identifier corresponding to the training log data.

14. The system of claim 11, wherein feedback, from which the training label is generated, comprises a rating.

15. The system of claim 11, wherein in the sentiment prediction model comprises one or more of a natural language processing (NLP) model and a transformer model.

16. The system of claim 11, wherein the sentiment prediction comprises a sentiment classification.

17. The system of claim 11, wherein the text generation model comprises one or more of an image to text model, a transformer model, a generative adversarial model, and a generative diffusion model.

18. The system of claim 11, wherein the application executes to:
obtain log statistics from system logs to form the log data.

19. The system of claim 11, wherein the log data comprises system logs with log events comprising successful start of a software service, successful termination of software service, and intermediate operation logs.

20. A method, comprising:
transmitting log data, wherein the log data is processed by:
processing the log data with a text generation model to generate synthesized text; and
processing the synthesized text with a sentiment prediction model to generate a sentiment prediction, wherein the sentiment prediction model is trained with a training label received responsive to a similarity score of a training vector meeting a similarity threshold; and
displaying the sentiment prediction.
